(19) United States
(12) Patent Application Publication
(10) Pub. No.: US 2003/0139086 A1
(43) Pub. Date: Jul. 24, 2003

(54) Structural improvement for power cord of hand tools

(76) Inventor: Hsing-Ming Chuang, Taoyuan Hsien (TW)

Correspondence Address: BRUCE H. TROXELL, Suite 1404, 5205 Leesburg Pike, Falls Church, VA, 22041, US

(21) Appl. No.: 10/050,181

(22) Filed: Jan. 18, 2002

(51) Int. Cl. H01R 13/56

(52) U.S. Cl. 439/448

(57) ABSTRACT

The present invention relates to a structural improvement for power cords of hand tools. Part of the power cord forms itself into several coils, allowing a shaping cable to penetrate through and be fastened to the two opposite ends of the coils. Since the shaping cable does not have any elasticity, it prevents the coils from loss of elastic deformation after frequent pulling. Especially for the place where the power cord connects to the hand tools or appliances, the power cord forms itself into several coils, through which a shaping cable penetrates. The shaping cable does not have any elasticity, so it shapes the coils firmly and allows the coils to maintain a constant radius. As a result, the breakage problem with the power cord due to single-point bending is solved through such coils that the bending point is delocalized with reduced bending angle and shifts with the swinging direction.

### FIELD OF THE INVENTION

The present invention relates to an improved structural design of the power cord, which may be applied to various small electromechanical devices such as band tools, hair blowers and portable electric drills, especially to strengthen the structure where the power cord meets the devices in a bending form and to enhance the anti-bending property for the power cord.

### BACKGROUND OF THE INVENTION

As shown in FIG. 1, the traditional power cord 1′ is designed to be linear. When users need to swing the hand tool constantly in different directions (like the hair blower used by a designer), bending occurs at the same point. Such single-point bending causes the conducting wires inside the power cord susceptible to breakage due to a large bending angle for the linear power cord 1′.

In FIG. 2, although the coiled power cord 2′ can solve the above-mentioned single-point bending problem, it can not maintain a constant coiling after frequent pulling action during a long time use. Therefore it deforms and is also susceptible to single-point breakage.

In view of such a breakage problem for traditional power cords, the inventor of the present invention was devoted to finding a solution and accomplished structural improvement for power cord.

### SUMMARY OF THE INVENTION

The main objective for the present invention is to solve the breakage problem due to single-point bending by the power cord forming itself into several coils at the place where the power cord connects to the hand tools or appliances, installing a shaping cable penetrating through the coils, fastening the shaping cable at the two opposite ends of the curve part, shaping the coils effectively with the rigid characteristic of the cable, maintaining the coils in constant radius, delocalizing the bending point subject to frequent bending, and finally shifting the bending point along with the swing direction.

In the following, the embodiment illustrated is used to describe the detailed structural characteristics and operation action for the present invention.

### BRIEF DESCRIPTION OF THE DRAWINGS

FIG. 1 is a three-dimensional illustration for single-point bending in a traditional linear power cord.

FIG. 2 is a three-dimensional illustration for deformation in a traditional coiled power cord.

FIG. 3 is a three-dimensional illustration for the power cord in the present invention.

FIG. 4 is a three-dimensional illustration for the shaping cable in the present invention.

FIG. 5 is a three-dimensional illustration for application of the present invention to a hair blower.

FIG. 6 is an illustration for bending of the power cord in the present invention.

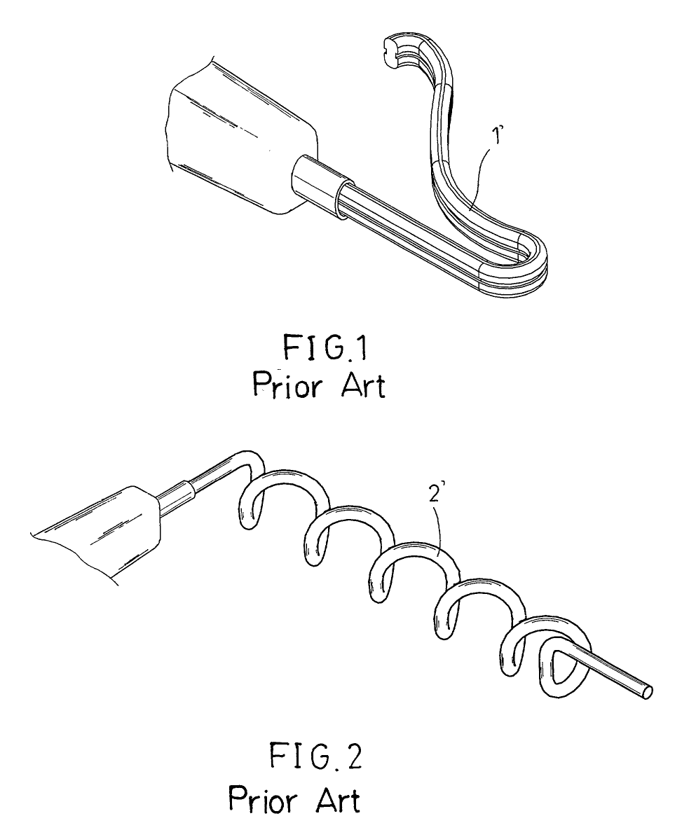

### DETAILED DESCRIPTION OF THE INVENTION

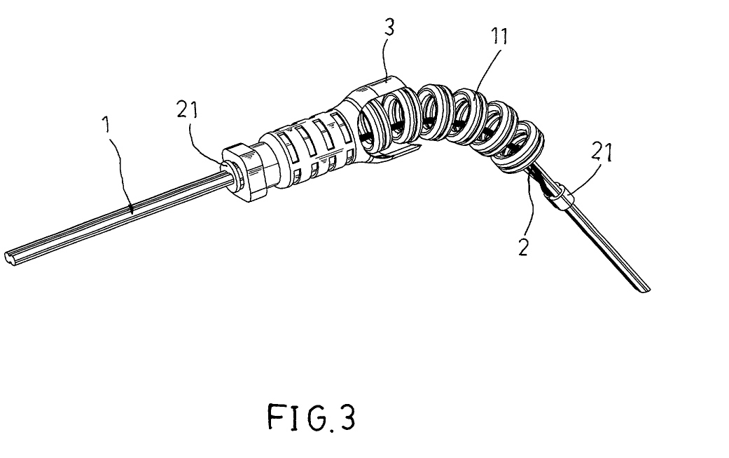

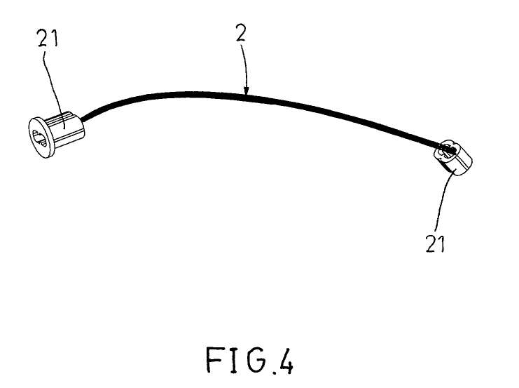

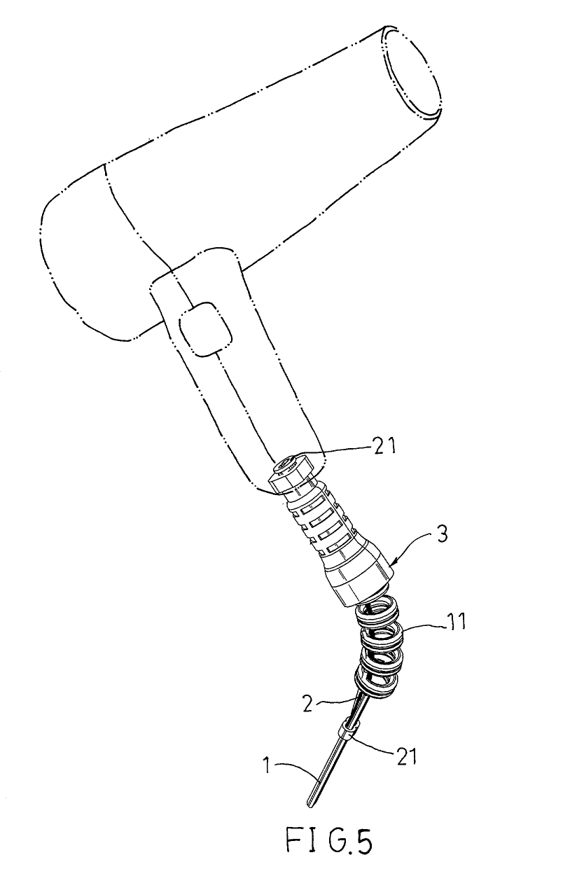

Please refer to FIGS. 3 to 5. The power cord 1 connects to the bottom of the handle of a hand tool or small appliance. A trumpet-like protective cover 3 is added to the connection place of the power cord 1 and the hand tool. The trumpet-like protective cover may encompass one or two coils of the power cord.

The power cord 1 forms itself into several coils 11 at the rear of the trumpet-like protective cover 3. The coils 11 include one or two coils inside the trumpet-like protective cover 3, so each bending angle is delocalized as the power cord is bent.

A shaping cable 2 penetrates through the coils 11 of the power cord 1. The shaping cable 2 has a fixed length, but does not have any elasticity. At the rear of the coils 11 and the trumpet-like protective cover 3 respectively, the shaping cable 2 is fastened to the power cord by fasteners 21.

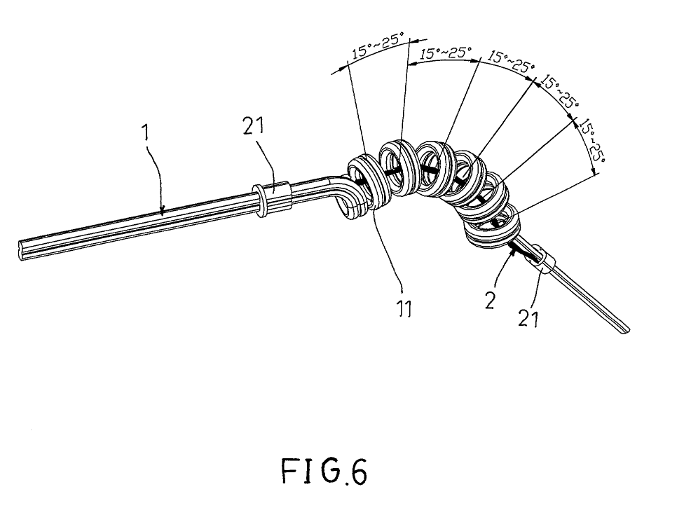

Please refer to FIGS. 3 and 6. Since the shaping cable 2 does not any elasticity, it provides elastic bending when it is fixed to the front and the rear of the coils 11. Restricted by the shaping cable 2, the coils 11 can maintain elastic bending and allows effective delocalization of the bending point into several places when the power cord 1 is bent again. The original bending angle from 90 degree to 180 degree can be changed to several angels in smaller degree. As shown in FIG. 6, due to restriction of the shaping cable 2 in the present invention, each bending angle for the coils 11 becomes smaller. Besides, the bending point shifts with the swinging direction. As a result, the life of the power cord is extended.

To summarize the above description, the power cord in the present invention can provide effective performance and extend its life through a simple structural improvement, which practically meets the qualifications for invention based on new type and improvement. Accordingly, an application is submitted for examination.

What is claimed is:

1. A structural improvement to extend life for a power cord of hand tools, having coils at a place where said power cord connects to said hand tool, characterized in that:
there are several coils at said power cord to allow a shaping cable to penetrate through and be fastened to said power cord; said shaping cable has no elasticity and is fixed to a front and a rear of said coils to prevent said coils from deformation and loss of elastic bending, and through said coils, a bending point is delocalized and shifts along with a swing direction of said hand tool.
